(19) United States
(12) Patent Application Publication
(10) Pub. No.: US 2013/0187878 A1
(43) Pub. Date: Jul. 25, 2013

(54) INPUT DEVICE THROUGH TOUCH PAD

(71) Applicant: PANASONIC CORPORATION, Osaka (JP)

(72) Inventor: Masahiro MUIKAICHI, Osaka (JP)

(73) Assignee: PANASONIC CORPORATION, Osaka (JP)

(21) Appl. No.: 13/733,661

(22) Filed: Jan. 3, 2013

(30) Foreign Application Priority Data
Jan. 5, 2012 (JP) 2012-000414

(51) Int. Cl. G06F 3/041

(52) U.S. Cl. CPC G06F 3/041
USPC 345/173

(57) ABSTRACT

An input device includes: a receiving unit for receiving a contact position on an input region of a touch pad on which a user's finger touches; and an input controller for determining a direction of movement of the finger according to a predetermined determining condition based on the contact position on the touch pad received from the receiving unit and outputting the direction of movement, wherein the input controller manages the input region of the touch pad by dividing the input region into a plurality of regions and changes the predetermined determining condition for each of the plurality of regions.

### BACKGROUND

1. Technical Field

The present disclosure relates to an input device through touch pad.

2. Related Art

Conventionally, touch pad-equipped remote controllers have been known. A user can perform predetermined input operations by dragging a finger or the like on a touch pad part of the touch pad-equipped remote controller. For example, when a user uni-directionally drags a finger on the touch pad, the direction and the amount of the movement may be translated into an event of pressing an up, down, left, or right move key and the count of the events.

JP H03-265919A describes an information processing device equipped with a touch panel. When one drags a finger on the touch panel of the information processing device described in JP H03-265919A, the device is capable of generating an event of pressing the down key in response to a downward dragging movement of the finger by a certain distance, and if the distance of the movement is long, the device is capable of repeating the generation of the event of pressing the down key each time the downward dragging movement of the finger by that distance is made.

### SUMMARY

When a user handles a touch pad of a remote controller by touching the pad by a finger, the user usually holds the remote controller and handles the touch pad by one hand. On that occasion, the user may unintentionally touch the pad, causing misrecognition of a move key by the touch pad.

The present disclosure presents an input device which makes fewer events of generating a move key signal unintentionally caused by the user, reducing misrecognition of a move key by the touch pad.

One non-limiting and exemplary embodiment provides an input device comprising: a receiving unit for receiving a contact position on an input region of a touch pad on which a user's finger touches; and an input controller for determining a direction of movement of the finger according to a predetermined determining condition based on the contact position on the touch pad received from the receiving unit and outputting the direction of movement, wherein the input controller manages the input region of the touch pad by dividing the input region into a plurality of regions and changes the predetermined determining condition for each of the plurality of regions.

The input device through touch pad with that configuration decreases events of generating a move key signal unintentionally caused by the user, reducing misrecognition of a move key by the touch pad.

By using the input device through touch pad according to the present disclosure, events of generating a move key signal unintentionally caused by the user decrease, therefore, misrecognition of a move key by the touch pad can be reduced.

### BRIEF DESCRIPTION OF DRAWINGS

FIG. 1 is a schematic block diagram of a remote control system according to a first embodiment including a touch pad-equipped remote controller and a playback device which is an input device;

FIG. 2 is a block diagram of the remote controller according to the first embodiment. It is a block diagram of the remote controller and the playback device according to the first embodiment;

FIG. 3 is a diagram simply illustrating movement of a right hand thumb tip on the touch pad on the remote controller according to the first embodiment and regions which are prone to misrecognition by the touch pad;

FIG. 4 is a block diagram of regions of the touch pad on the remote controller according to the first embodiment;

FIGS. 5(a) to 5(c) are diagrams for describing attributes of the regions of the touch pad on the remote controller according to the first embodiment and respectively represent relationship between directions of movement of the thumb and kinds of move key signals to be generated;

FIG. 6 is a flow chart describing operations of the playback device according to the first embodiment, particularly an input controller of a controller, to generate a move key signal from a direction of movement of the thumb and a moved distance;

FIG. 7 is a block diagram of another example of regions of the touch pad on the remote controller according to the first embodiment;

FIG. 8 is a diagram illustrating an example of a line shown by a contact point of the finger on the touch pad of the remote controller according to a second embodiment;

FIG. 9 is a flow chart describing operations of the playback device according to the second embodiment to generate a move key signal from a direction of movement of the thumb and a moved distance;

FIG. 10 is a variation of the flow chart describing operations of the playback device according to the second embodiment, particularly the input controller of the controller, to generate a move key signal from a direction of movement of the thumb and a moved distance;

FIG. 11(a) is a diagram illustrating a locus of a touch in the case where a user holds the remote controller in the right hand and moves the finger in the downward direction; FIG. 11(b) is a diagram illustrating a locus of a touch in the case where the user holds the remote controller in the left hand and moves the finger in the downward direction; FIG. 11(c) is a diagram illustrating a locus of a touch in the case where the user holds the remote controller in the right hand and moves the finger in the rightward direction; and FIG. 11(d) is a diagram illustrating a locus of a touch in the case where the user holds the remote controller in the left hand and moves the finger in the leftward direction.

### DETAILED DESCRIPTION OF PREFERRED EMBODIMENT

Embodiments will be described below in detail with reference to the drawings as required. However, unnecessarily detailed description may be omitted. For example, detailed description of already known matters and redundant description of substantially the same configuration may be omitted. All of such omissions are for avoiding unnecessary redundancy in the following description to facilitate understanding by those skilled in the art.

The inventor provides the attached drawings and the following description for those skilled in the art to fully understand the present disclosure and does not intend to limit the subject described in the claims by the attached drawings and the following description.

### 1. First Embodiment

When a user uses a touch pad-equipped remote controller, the user usually operates the remote controller by one hand. In the case where the user holds the remote controller in one hand and moves the finger on the touch pad, the thumb tends to turn around in a circle on the knuckle of the thumb.

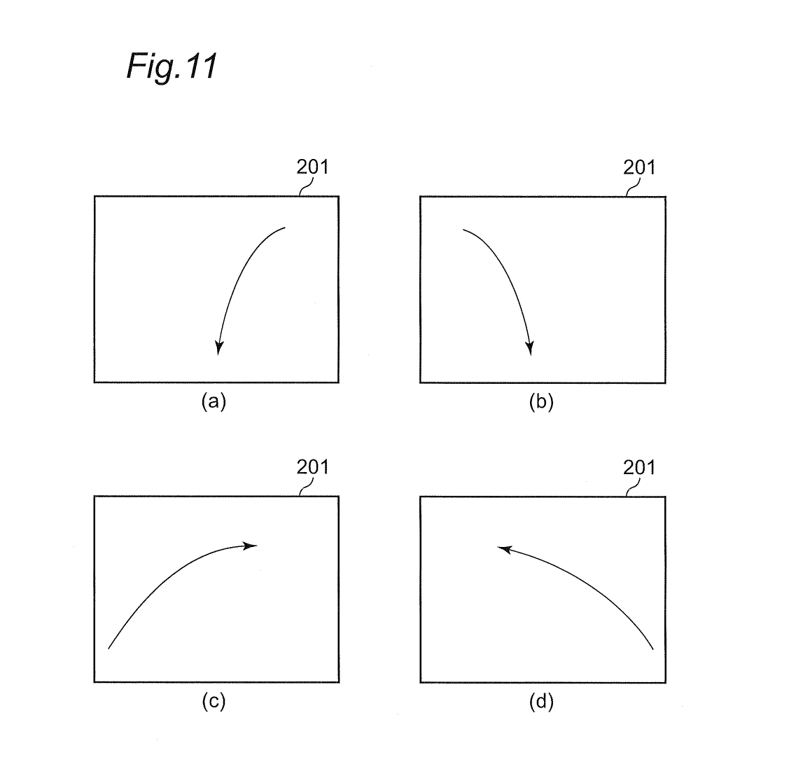

FIG. 11(a) is a diagram illustrating a locus of a touch in the case where a user holds the remote controller in the right hand and moves the finger in the downward direction, for example. On that occasion, in spite of the intention of moving the finger in the downward direction, the user cannot help moving the finger nearly in the leftward direction at first. Although the user thinks the user is moving the finger in the downward direction, such an event may occur in which the remote controller recognizes that the finger moves in the leftward direction. Therefore, there is a problem in that inputting of the left key may occur for a while after the user starts moving the finger.

FIG. 11(b) is a diagram illustrating a locus of a touch in the case where the user holds the remote controller in the left hand and moves the finger in the downward direction. FIG. 11(c) is a diagram illustrating a locus of a touch in the case where the user holds the remote controller in the right hand and moves the finger in the rightward direction. And, FIG. 11(d) is a diagram illustrating a locus of a touch in the case where the user holds the remote controller in the left hand and moves the finger in the leftward direction. Similar to the case of FIG. 11(a), there are problems in the respective cases in that inputting of the right key, the up key, and the up key may occur (i.e., substantial misrecognition by the touch pad may occur) for a while after the user starts moving the finger.

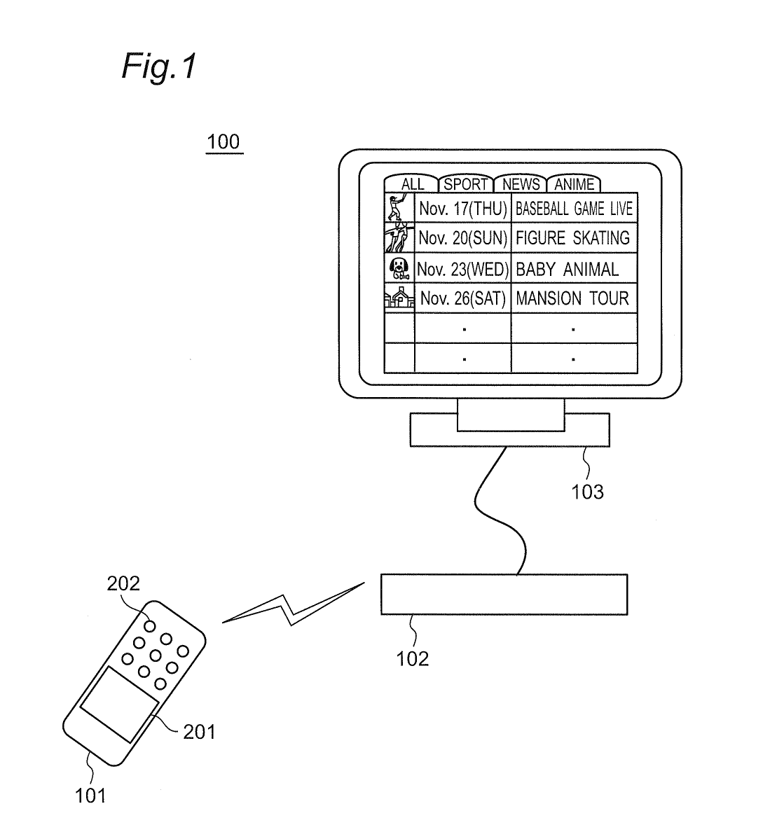

The remote control system according to the first embodiment is configured to overcome the problems. The first embodiment will be described below with reference to FIGS. 1 to 7.

[1-1. Configuration]

FIG. 1 is a schematic block diagram of a remote control system according to the first embodiment including a touch pad-equipped remote controller and a playback device which is an input device. A remote control system 100 includes a remote controller 101, a playback device 102, and a monitor 103.

The remote controller 101 translates the user's operation into a signal and sends it to the playback device 102. The playback device 102, which is a device for reproducing such contents as a video content and a music content, also generates a GUI (Graphic User Interface) to be displayed on the monitor 103 for the user to select or edit the content to be reproduced. The monitor 103 displays a video signal output from the playback device 102 as a video and outputs an audio signal as audio.

Therefore, the GUI displayed on the monitor 103 is operated by the signal sent from the remote controller 101, and the reproduced image of the content and the GUI generated by the playback device 102 are output to the monitor 103 as the video signal and the audio signal.

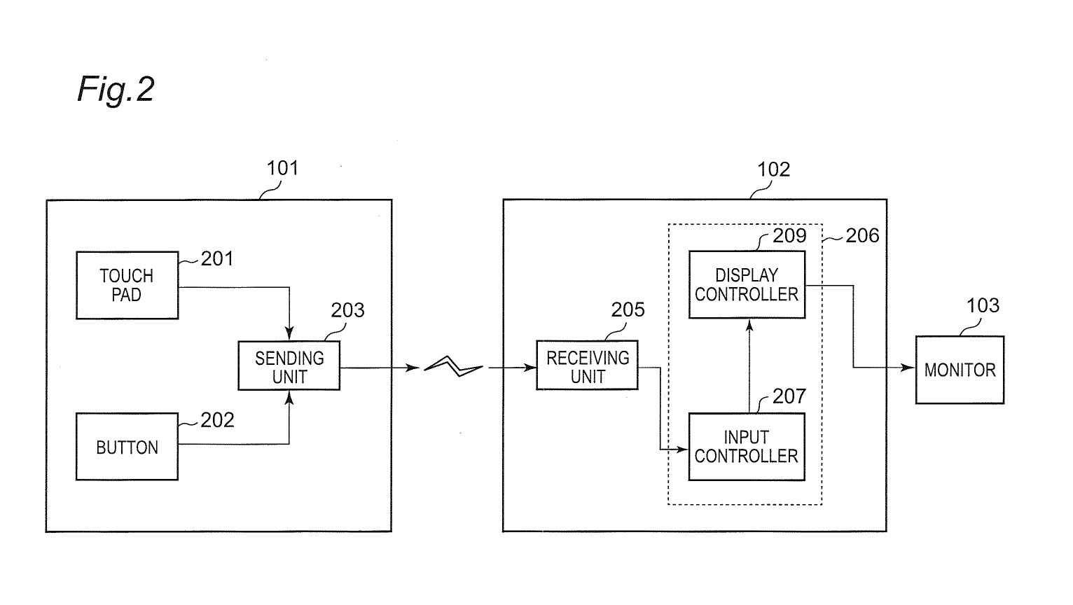

FIG. 2 is a block diagram of the remote controller 101 and the playback device 102 according to the first embodiment. The remote controller 101 includes a touch pad 201, buttons 202, and a sending unit 203. The touch pad 201 keeps periodically sensing the coordinates of the contact points on the touch pad and sending the sensed coordinates data of the contact points to the sending unit 203 between the time when the finger touches the touch pad and the time when the finger leaves the touch pad. Between the time when the button on the remote controller is pressed and the time when the button is released, the button 202 keeps sending identification information of the button to the sending unit 203 indicating which button is pressed. The sending unit 203 sends the coordinates data of the contact points sent from the touch pad 201 and the identification information of the button sent from the button 202 to the playback device 102.

The playback device 102 includes a receiving unit 205 and a controller 206. The controller 206 includes an input controller 207 and a display controller 209. The receiving unit 205 receives the coordinates data of the contact points on the touch pad 201 and the identification information of the button 202 wirelessly sent from the remote controller 101. The input controller 207 generates display signals based on the data received by the receiving unit 205 and respective types of data stored in a data recording unit (not shown) provided for the playback device 102 such as a hard disk and a magnetic storage medium loaded into the playback device 102 such as a compact disk, and then transmits the display signals to the display controller 209. The display controller 209 edits the display signals transmitted from the input controller 207 to make it in the form to be displayed on the monitor 103 and then sends the signals to the monitor 103.

Here, the controller 206 that contains the input controller 207 and the display controller 209 is a data processing unit for controlling over an external device and respective components which constitute the playback device 102 by processing the input signals and data and outputting respective control signals and control data. The data processing unit (controller 206) is implemented by cooperation of a processor and programs on a memory. The data processing unit (controller 206) may also be implemented by a hard-wired element capable of providing functions according to the present embodiment. As such, the playback device 102 has hardware resources such as a processor, a memory, a hard disk, a compact disk reader, and the like.

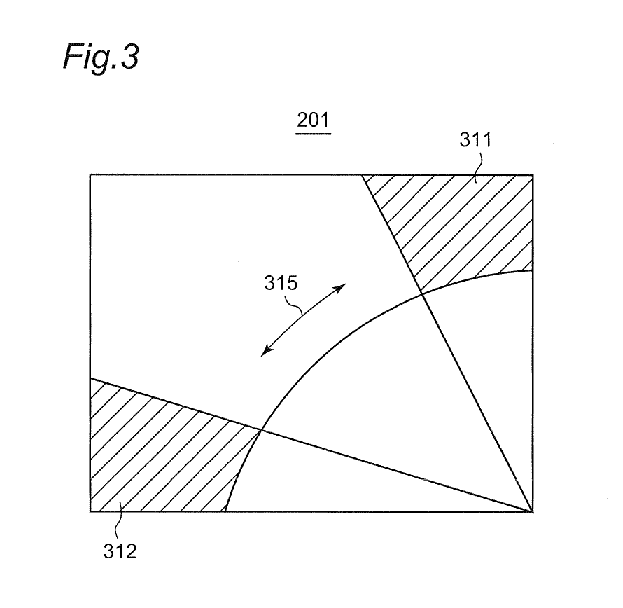

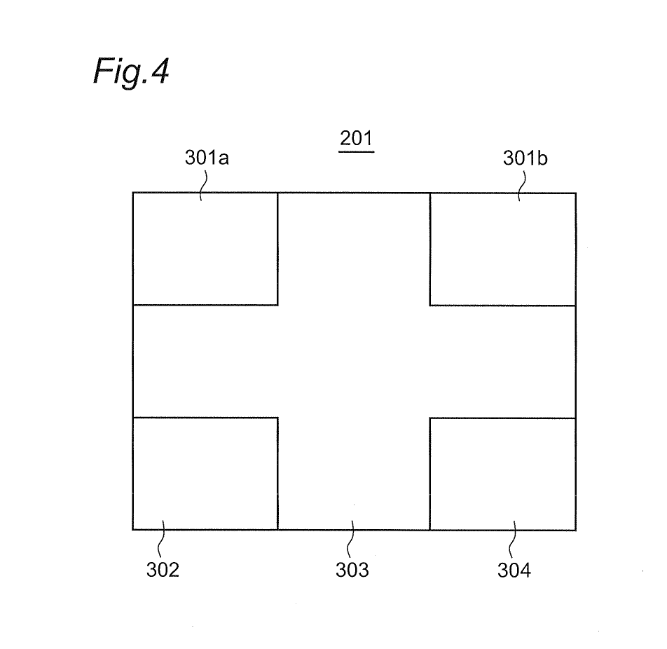

FIG. 3 is a diagram simply illustrating movement of a right hand thumb tip on the touch pad 201 on the remote controller 101 according to the first embodiment and regions which are prone to misrecognition by the touch pad 201. FIG. 4 is a block diagram of regions of the touch pad 201 on the remote controller 101 according to the first embodiment.

As illustrated in FIG. 3, when the user holds the remote controller 101 in the right hand, the right hand thumb tip tends to turn around in an arc of a circle on the knuckle of the thumb on the touch pad 201 as indicated by an arrow 315. In that case, in a top right corner region 311, although the user intends to move the finger in the downward direction, a movement component in the right-left direction is frequently mixed as illustrated in FIG. 11(a), especially at the beginning of the movement. Further in the top right corner region 311, although the user intends to move the finger in the upward direction, especially the locus of the end of the movement is frequently made in a circular arc (i.e., a movement component in the right-left direction is mixed especially at the end of the movement). Similarly, in a bottom left corner region 312, although the user intends to move the finger in the rightward direction, a movement component in the up-down direction is frequently mixed as illustrated in FIG. 11(c), especially at the beginning of the movement. Further in the bottom left corner region 312, although the user intends to move the finger in the leftward direction, especially the locus of the end of the movement is frequently made in a circular arc (i.e., a movement component in the up-down direction is mixed especially at the end of the movement). Such mixing of the movement component in the direction different from the user's intention frequently occurs in regions at distant from the knuckle of the thumb.

Taking account of that matter, in the touch pad 201 on the remote controller 101 according to the first embodiment, a top right corner region 301b illustrated in FIG. 4 is taken as a region in which up-down direction move keys are given priority to occur and a bottom left corner region 302 illustrated in FIG. 4 is taken as a region in which right-left direction move keys are given priority to occur. The “region in which an up-down direction (or right-left direction) move key is given priority to occur” will be described in detail below.

Further, in the touch pad 201 on the remote controller 101 according to the first embodiment, on the assumption that the user holds the remote controller 101 in the left hand, a top left corner region 301a illustrated in FIG. 4 is taken as a region in which up-down direction move keys are given priority to occur and a bottom right corner region 304 illustrated in FIG. 4 is taken as a region in which the right-left direction move keys are given priority to occur. Meanwhile, a normal region 303 is a region in which both the up-down direction move keys and the right-left direction move keys equally occur.

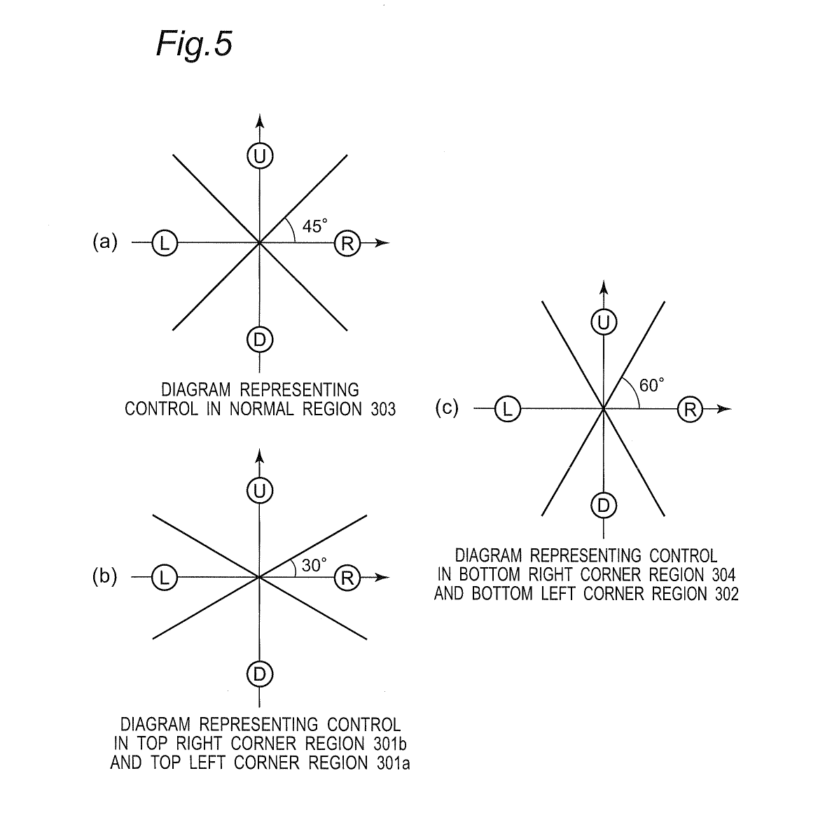

FIGS. 5(a) to 5(c) are diagrams for describing attributes of the regions (301a, 301b, 302, 303, and 304) of the touch pad 201 on the remote controller 101 according to the first embodiment and respectively represent relationship between directions of movement of the thumb and kinds of move key signals to be generated (in the input controller 207 of the playback device 102). First, FIG. 5(a) is a diagram representing relationship between directions of movement of the thumb and move key signals to be generated (in the input controller 207 of the playback device 102) in the normal region 303. The angle of the direction of movement of the finger is θ, where the present position (contact position) of the finger is assumed to be the origin of coordinates O and the angle of the positive horizontal direction from the viewpoint of the origin O is assumed to be zero degrees. The relationship between θ and the types of move key signal to be generated (in the input controller 207 of the playback device 102) in FIG. 5(a) is shown in Table 1 below.

TABLE 1

| | Move key signal to |
|---|---|
| Direction of movement (angle) | be generated |
| 0 degrees ≦ θ < 45 degrees, | Right key |
| 315 degrees ≦ θ < 360 degrees | |
| 45 degrees ≦ θ < 135 degrees | Up key |
| 135 degrees ≦ θ < 225 degrees | Left key |
| 225 degrees ≦ θ < 315 degrees | Down key |

Next, FIG. 5(b) is a diagram representing relationship between directions of movement of the thumb and move key signals to be generated (in the input controller 207 of the playback device 102) in the top right corner region 301b and the top left corner region 301a. The top right corner region 301b and the top left corner region 301a are taken as the regions in which the up-down direction move keys are given priority to occur and, in FIG. 5(b), the relationship between θ and the types of move key signals to be generated (in the input controller 207 of the playback device 102) is shown in Table 2 below.

TABLE 2

| | Move key signal to |
|---|---|
| Direction of movement (angle) | be generated |
| 0 degrees ≦ θ < 30 degrees, | Right key |
| 330 degrees ≦ θ < 360 degrees | |
| 30 degrees ≦ θ < 150 degrees | Up key |
| 150 degrees ≦ θ < 210 degrees | Left key |
| 210 degrees ≦ θ < 330 degrees | Down key |

Next, FIG. 5(c) is a diagram representing relationship between directions of movement of the thumb and the types of move key signals to be generated (in the input controller 207 of the playback device 102) in the bottom right corner region 304 and the bottom left corner region 302. The bottom right corner region 304 and the bottom left corner region 302 are taken as the regions in which the right-left direction move key is given priority to occur and, in FIG. 5(c), the relationship between θ and the types of move key signals to be generated (in the input controller 207 of the playback device 102) is shown in Table 2 below.

TABLE 3

| | Move key signal to |
|---|---|
| Direction of movement (angle) | be generated |
| 0 degrees ≦ θ < 60 degrees, | Right key |
| 300 degrees ≦ θ < 360 degrees | |
| 60 degrees ≦ θ < 120 degrees | Up key |
| 120 degrees ≦ θ < 240 degrees | Left key |
| 240 degrees ≦ θ < 300 degrees | Down key |

The relationship between the directions of movement of the thumb and the types of move key signal to be generated in the regions (301a, 301b, 302, 303, and 304) of the touch pad 201 as shown in Table 1 to Table 3 is controlled by the input controller 207 of the playback device 102 based on the coordinates data of the contact points on the touch pad 201 periodically sent from the remote controller 101. That control may be taken by the remote controller 101 as described later.

[1-2. Operation]

The operations of the touch pad 201 and the playback device 102 according to the first embodiment of the above described configuration will be described below. In the touch pad 201 and the playback device 102 according to the first embodiment, the relationship between directions of movement of the thumb and the types of move key signal to be generated as illustrated in FIGS. 5(a), 5(b), and 5(c) is used properly for each of the regions defined as illustrated in FIG. 4.

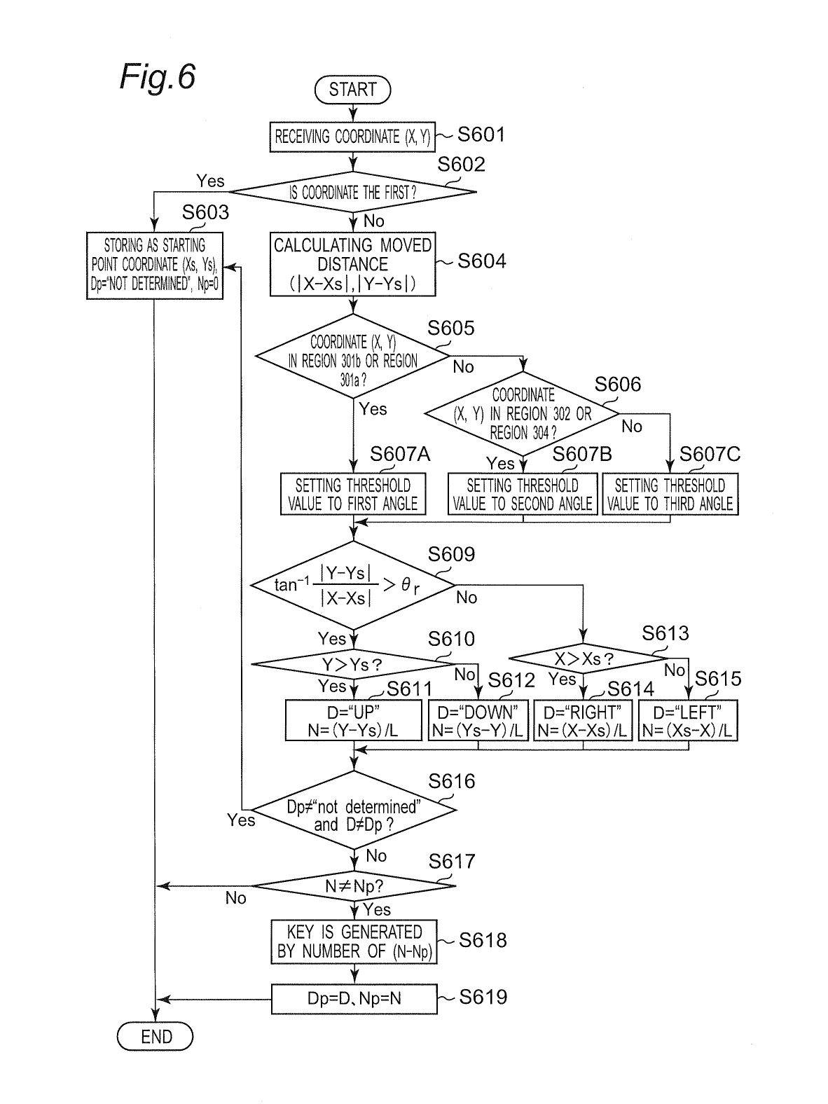

FIG. 6 is a flow chart describing operations of the playback device 102 according to the first embodiment, particularly the input controller 207 of the controller 206, to generate a move key signal from the direction of movement of the thumb and the moved distance.

First, as described previously, while the finger is touching the touch pad 201, the coordinates data of the contact point (X, Y) is periodically sent from the remote controller 101 to the playback device 102. The playback device 102 receives the coordinates data of the contact point (X, Y) (step S601).

When the received coordinates data of the contact point (X, Y) is the first coordinates after the finger touches the touch pad (step S602, Yes), the controller 206 of the playback device 102 stores the coordinates as starting point coordinates (Xs, Ys) (step S603). On that occasion, the controller 206 initializes a parameter Dp which represents the direction of the move key signal generated at the previous reception of the coordinates data of the contact point. Dp is a parameter to which data indicating any of five states of “up”, “down”, “left”, “right”, and “not determined” is set. At the initialization time, “not determined” is set to Dp. Also on that occasion, the controller 206 initializes the number of keys Np generated until the previous reception (of the coordinates data of the contact point) to 0.

On the other hand, when the received coordinates data of the contact point (X, Y) is the second or later coordinates after the finger touches the touch pad (step S602, No), the controller 206 of the playback device 102 calculates the moved distance (|X−Xs|, |Y−Ys|) from the starting point coordinates (Xs, Ys) (step S604). Next, the controller 206 compares the coordinates (X, Y) with the regions illustrated in FIG. 4. When the coordinates (X, Y) are in the top right corner region 301b or the top left corner region 301a (step S605, Yes), the controller 206 sets a threshold value for comparison to a first angle, for example 30 degrees (step S607A). The setting process of the threshold value for comparison to the first angle (for example, 30 degrees) means the controlling illustrated in FIG. 5(b). Here, the coordinates (X, Y) are in the region in which the up-down direction move keys are given priority to occur.

When the coordinates (X, Y) are in the bottom left corner region 302 or the bottom right corner region 304 (step S605, No, and step S606, Yes), the controller 206 sets the threshold value for comparison to a second angle, for example 60 degrees (step S607B). The setting process of the threshold value for comparison to the second angle (for example, 60 degrees) means the controlling illustrated in FIG. 5(c). Here, the coordinates (X, Y) are in the region in which the right-left direction move key is given priority to occur.

In the other case, i.e., when the coordinates (X, Y) are in the normal region 303 (step S605, No, and step S606, No), the controller 206 sets the threshold value for comparison to a third angle, for example 45 degrees (step S607C). The setting of the threshold value for comparison to 45 degrees of the third angle means the controlling illustrated in FIG. 5(a), though, as is apparent from FIG. 5(a), both the up-down direction move keys and the right-left direction move keys will equally occur.

After the threshold value for comparison is set in steps S607A, S607B, and S607C, determination is made as to whether the tilt angle calculated from the ratio of the moved distance in the x-direction and the moved distance in the y-direction is larger than the threshold value for comparison as shown in Expression 1 below (step S609). Here, “θT” represents the threshold value for comparison.

$${tan}^{- 1} \frac{\vert Y - Ys \vert}{\vert X - Xs \vert} > {θ}_{T} \qquad [ Expression 1 ]$$

When the tilt angle calculated from the ratio of the moved distance in the x-direction and the moved distance in the y-direction is larger than the threshold value for comparison (step S609, Yes), the value Ys of the y-coordinate of the starting point is compared with the current value Y of the y-coordinate (step S610). When the current value Y of the y-coordinate is larger (step S610, Yes), it is assumed that the finger has moved in the upward direction and data indicating “up” is set to a parameter D which indicates the currently calculated direction of movement. At the same moment, the value of the moved distance from the y-coordinate of the starting point divided by a constant L is calculated by Expression 2 below as the number of move keys N to be generated for the movement from the starting point (step S611).

N=(Y−Ys)/L [Expression 2]

When it is determined that the current value Y of the y-coordinate is smaller in step S610 (step S610, No), it is assumed that the finger has moved in the downward direction and data indicating “down” is set to the parameter D which indicates the currently calculated direction of movement. At the same moment, the number of move keys N to be generated for the movement from the starting point is calculated by Expression 3 below in almost the same manner as in step S611 (step S612).

N=(Ys−Y)/L [Expression 3]

When the tilt angle calculated from the ratio of the moved distance in the x-direction and the moved distance in the y-direction is smaller than the threshold value for comparison (step S609, No), the value Xs of the x-coordinate of the starting point is compared with the current value X of the x-coordinate (step S613). When the current value X of the x-coordinate is larger (step S613, Yes), it is assumed that the finger has moved in the rightward direction and data indicating “right” is set to the parameter D which indicates the currently calculated direction of movement. At the same moment, the value of the moved distance from the x-coordinate of the starting point divided by the constant L is calculated by Expression 4 below as the number of move keys N to be generated for the movement from the starting point (step S614).

N=(X−Xs)/L [Expression 4]

When it is determined that the current value X of the x-coordinate is smaller in step S613 (step S613, No), it is assumed that the finger has moved in the leftward direction and data indicating “left” is set to the parameter D which indicates the currently calculated direction of movement. At the same moment, the number of move keys N to be generated for the movement from the starting point is calculated by Expression 5 below in almost the same manner as in step S614 (step S615).

N=(Xs−X)/L [Expression 5]

When the parameter Dp has the setting other than “not determined” and also the currently calculated direction of movement D disagrees with the last time calculated direction of movement Dp thereafter (step S616, Yes), it is assumed that the direction of movement has changed from the last time direction of movement and reinitialization is performed (step S603).

On the other hand, when it is determined that the parameter Dp has the setting “not determined” or when it is determined that the currently calculated direction of movement D is the same as the last time calculated direction of movement Dp in step S616 (step S616, No), determination is made as to whether the number of keys Np generated until the last time is the same as the number of the currently calculated move keys N (step S617). When N is different from Np (step S617, Yes), the move key signal in the direction set to the parameter D is generated by the number of (N−Np) (step S618), the setting of D is set to “Dp” and the setting of N is set to “Np” to update Dp and Np (step S619).

When it is determined that N is the same as Np in step S617 (step S617, No), it is assumed that a new move key needs not to be generated.

The process steps from step S601 through step S619 are repeated by the controller 206 of the playback device 102 while a finger is touching the touch pad 201, and the input controller 207 of the playback device 102 generates one or more move key signals according to the condition.

[1-3. Effects]

As stated above, an input device according to the present embodiment includes: a receiving unit for receiving a contact position on an input region of a touch pad on which a user's finger touches; and an input controller for determining a direction of movement of the finger according to a predetermined determining condition based on the contact position on the touch pad received from the receiving unit and outputting the direction of movement. Therein, the input controller manages the input region of the touch pad by dividing the input region into a plurality of regions and changes the predetermined determining condition for each of the plurality of regions.

The remote control system according to the present embodiment including the touch pad-equipped remote controller and the playback device which is an input device changes the move key signal to be preferentially generated for each of the contact areas on the touch pad with the finger, thereby reducing the events of generating a move key signal unintentionally caused by the user of the system, therefore, reducing substantial misrecognition of a move key by the touch pad.

[1-4. Variation]

As described above, the regions of the touch pad 201 on the remote controller 101 according to the first embodiment are set as illustrated in FIG. 4. However, the setting method of the regions of the touch pad 201 is not limited to that illustrated in FIG. 4.

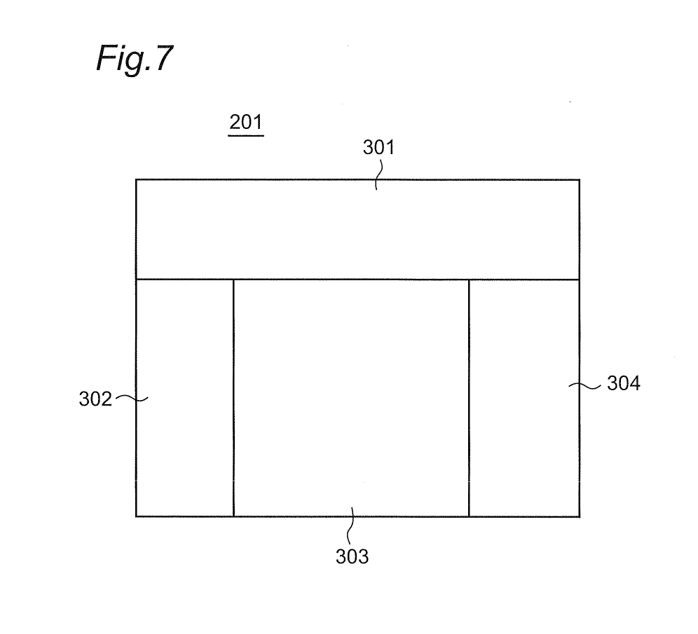

For example, the regions may be set as illustrated in FIG. 7. On the touch pad 201 illustrated in FIG. 7, the region 301 in which the up-down direction move keys are given priority to occur is set in the upper part in the right-left direction. The region 301 is set like that because when the user holds the remote controller 101 in one hand and touches the touch pad 201 to indicate movement by the finger, the finger less frequently comes in contact with the touch pad 201 in the upper center part of the touch pad 201 than in the upper right and left parts of the touch pad 201. In addition, overall arrangement of the touch pad 201 is simpler when the region in which the up-down direction move keys are given priority to occur is provided as an integral part.

Further, on the touch pad 201 illustrated in FIG. 7, the regions 302 and 304 in which the right-left direction move keys are given priority to occur are set longitudinally in the right and left parts below the region 301. The regions 302 and 304 are set like that because when the user holds the remote controller 101 in one hand and touches the touch pad 201 to indicate the right-left direction movement by the finger, the entire locus of the movement often staggers in the longitudinal direction. In addition, overall arrangement of the touch pad 201 is simpler when the regions 302 and 304 in which the right-left direction move keys are given priority to occur are respectively provided as integral parts longitudinally below the region 301.

### 2. Second Embodiment

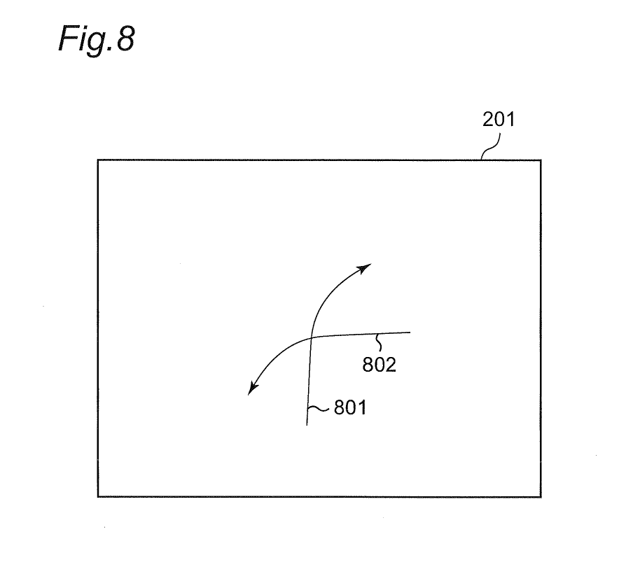

A second embodiment will be described below with reference to FIGS. 8 to 10. Schematic configuration of the remote control system according to the second embodiment is illustrated in FIGS. 1 and 2. That is, the schematic configuration of the remote control system according to the second embodiment is substantially the same as that of the first embodiment.

The second embodiment is featured as below. The touch pad of the remote controller according to the first embodiment is intended to reduce substantial misrecognition of a move key by using the contact areas with the finger. Unlike the first embodiment, the second embodiment is intended to further reduce substantial misrecognition of a move key based on time-series data of the contact with the finger. That is, the touch pad of the remote controller according to the second embodiment begins to keep preferentially generating the up-down direction move keys when the finger starts to move in the longitudinal direction on the touch pad, and begins to keep preferentially generating the right-left direction move keys when the finger starts to move in the right-left direction on the touch pad. In other words, the touch pad of the remote controller according to the second embodiment preferentially recognizes the last direction of movement.

In the touch pad 201 of the remote controller according to the second embodiment, when the contact point with the finger draws an upward line which curves to the right along a first line 801 as illustrated in FIG. 8, a signal related with an upward direction move key is given priority to occur. Similarly, when the contact point with the finger draws a leftward line which curves downward along a second line 802, a signal related with a leftward direction move key is given priority to occur.

Therefore, the touch pad of the remote controller according to the second embodiment keeps stably recognizing the direction of movement of the finger after the finger first touched the touch pad even if the direction of movement of the finger staggers to some extent while the finger is touching the touch pad.

As described previously, the configuration of the remote control system 100 as well as the configuration of the remote controller 101 and the playback device 102 according to the second embodiment are substantially the same as those of the first embodiment illustrated in FIGS. 1 and 2. In short, the second embodiment differs from the first embodiment in the control that the input controller 207 of the playback device 102 performs based on the coordinates data of the contact points on the touch pad 201 periodically sent from the remote controller 101. That control may be taken by the remote controller 101 as described above.

[2-1. Operation]

The operations of the touch pad 201 and the playback device 102 according to the second embodiment will be described below.

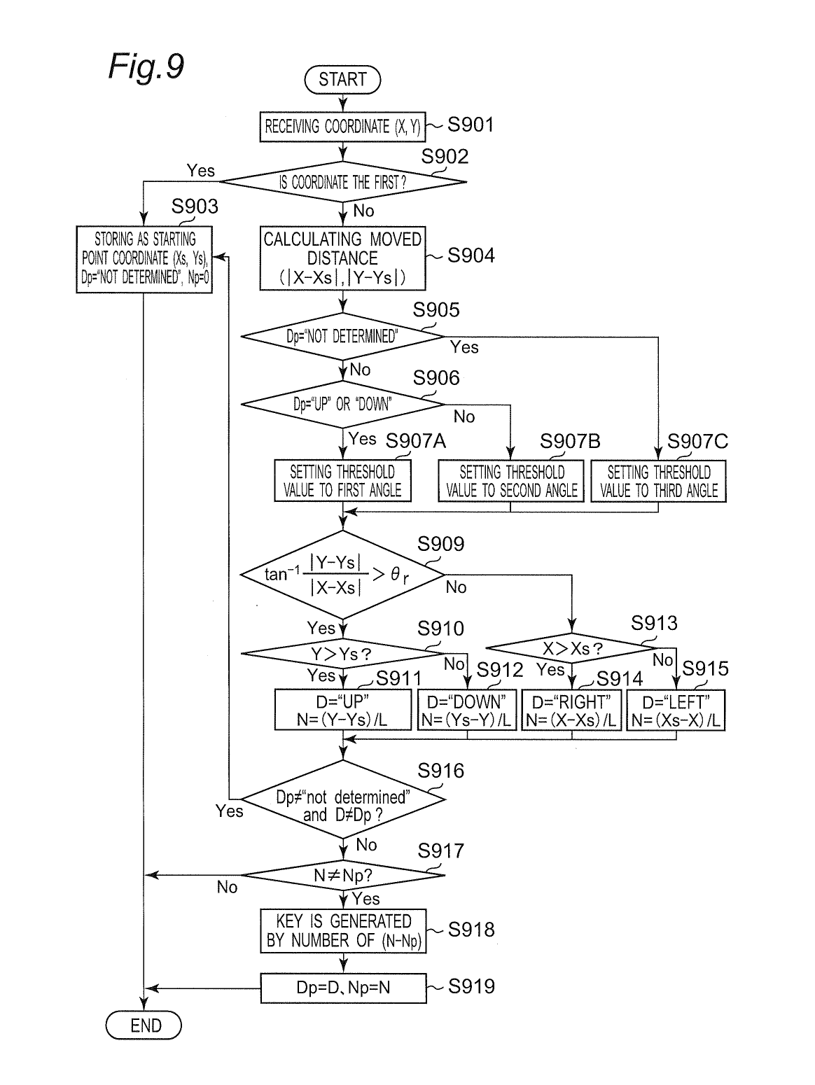

FIG. 9 is a flow chart describing operations of the playback device 102 according to the second embodiment, particularly the input controller 207 of the controller 206, to generate a move key signal from the direction of movement of the thumb and the moved distance. The flow chart shown in FIG. 9 is substantially the same as that shown in FIG. 6 according to the first embodiment. Therefore, differences between the two will be principally described below.

The flow chart shown in FIG. 9 is the same as that shown in FIG. 6 in that while the finger is touching the touch pad 201, the coordinates data of the contact point (X, Y) is periodically sent from the remote controller 101 to the playback device 102 and the playback device 102 receives the coordinates data of the contact point (X, Y) (step S901).

The flow chart shown in FIG. 9 is also the same as that shown in FIG. 6 in that when the received coordinates data of the contact point (X, Y) is the first coordinates after the finger touches the touch pad (step S902, Yes), the controller 206 of the playback device 102 stores the coordinates as starting point coordinates (Xs, Ys), and at the same time, initializes the parameter Dp which represents the direction of the move key signal generated at the previous reception of the coordinates data of the contact point as well as the number of keys 110 generated until the previous reception (step S903).

The flow chart shown in FIG. 9 is also the same as that shown in FIG. 6 in that when the received coordinates data of the contact point (X, Y) is the second or later coordinates after the finger touches the touch pad (step S902, No), the controller 206 of the playback device 102 calculates the moved distance (|X−Xs|, |Y−Ys|) from the starting point coordinates (Xs, Ys) (step S904).

Next, determination is made as to whether data indicating “not determined” is set to the parameter Dp which represents the direction of the move key signal generated at the previous reception of the coordinates data of the contact point (step S905). When the data other than “not determined” is set to the parameter Dp (step S905, No) and also the data indicates “up” or “down” (step S906, Yes), the controller 206, in response to the event that the finger starts moving in the longitudinal direction on the touch pad, sets the threshold value for comparison to a first angle, for example 30 degrees, to keep preferentially generating the up-down direction move keys (step S907A). The setting process of the threshold value for comparison to the first angle (for example, 30 degrees) means the controlling illustrated in FIG. 5(b). Here, it is in the condition that the up-down direction move keys are preferentially generated as illustrated in FIG. 5(b).

When the data other than “not determined” is set to the parameter Dp (step S905, No) and also the data indicates “left” or “right” (step S906, No), the controller 206, in response to the event that the finger starts moving in the right-left direction on the touch pad, sets the threshold value for comparison to a second angle, for example 60 degrees, to keep preferentially generating the right-left direction move key (step S907B). The setting process of the threshold value for comparison to the second angle (for example, 60 degrees) means the controlling illustrated in FIG. 5(c). Here, it is in the condition that the right-left direction move key is preferentially generated as illustrated in FIG. 5(c).

On the other hand, when the data indicating “not determined” is set to the parameter Dp (step S905, Yes), the controller 206, in response to the condition that the finger has not started moving on the touch pad, sets the threshold value for comparison to a third angle, for example 45 degrees, to equally generate both the up-down direction move keys and the right-left direction move keys (step S907C). The setting process of the threshold value for comparison to 45 degrees of the third angle means the controlling illustrated in FIG. 5(a). Here, as is apparent from FIG. 5(a), both the up-down direction move keys and the right-left direction move keys may equally occur.

The flow chart shown in FIG. 9 is the same as that shown in FIG. 6 (step S609) in that, after the threshold value for comparison is set in steps S907A, S907B, and S907C, determination is made as to whether the tilt angle calculated from the ratio of the moved distance in the x-direction and the moved distance in the y-direction by using Expression 1 is larger than the threshold value for comparison (step S909).

The flow chart shown in FIG. 9 is the same as that shown in FIG. 6 (step S610, step S613, step S611, step S612, step S614, and step S615) in that the controller 206 sets the parameter D which indicates the currently calculated direction of movement and the number of move keys N to be generated for the movement from the starting point based on the determination result of step S909 and the comparison result of the value Ys of the y-coordinate of the starting point with the current value Y of the y-coordinate or the comparison result of the value Xs of the x-coordinate of the starting point with the current value X of the x-coordinate (step S910, step S913, step S911, step S912, step S914, and step S915).

The flow chart shown in FIG. 9 is the same as that shown in FIG. 6 (step S616 and step S603) in that when the parameter Dp has the setting other than “not determined” and also the currently calculated direction of movement D disagrees with the last time calculated direction of movement Dp thereafter (step S916, Yes), it is assumed that the direction of movement has changed from the last time direction of movement and reinitialization is performed (step S903).

The flow chart shown in FIG. 9 is the same as that shown in FIG. 6 (step S618 and step S619) in that when it is otherwise determined that the parameter Dp has the setting “not determined” or when it is determined that the currently calculated direction of movement D is the same as the last time calculated direction of movement Dp in step S916 (step S916, No), the move key signal in the direction set to the parameter D is generated by the number of (N−Np) as required, and then the setting of D is set to “Dp” and the setting of N is set to “Np” to update Dp and Np (step S918 and step S919).

The process steps from step S901 through step S919 are repeated by the controller 206 of the playback device 102 while the finger is touching the touch pad 201, and the input controller 207 of the playback device 102 generates one or more move key signals according to the condition.

[2-3. Effects]

As stated above, an input device according to the present embodiment includes: a receiving unit for receiving a contact position on an input region of a touch pad on which a user's finger touches; and an input controller for determining a direction of movement of the finger according to a predetermined determining condition based on the contact position on the touch pad received from the receiving unit and outputting the direction of movement. Therein, the input controller changes the predetermined determining condition based on an immediately before direction of movement of the finger on the touch pad.

The remote control system according to the present embodiment including the touch pad-equipped remote controller and the playback device which is an input device changes the move key signal to be preferentially generated for each of the contact histories on the touch pad with the finger, thereby reducing the events of generating a move key signal unintentionally caused by the user of the system, therefore, reducing substantial misrecognition of a move key by the touch pad.

[2-3. Variation]

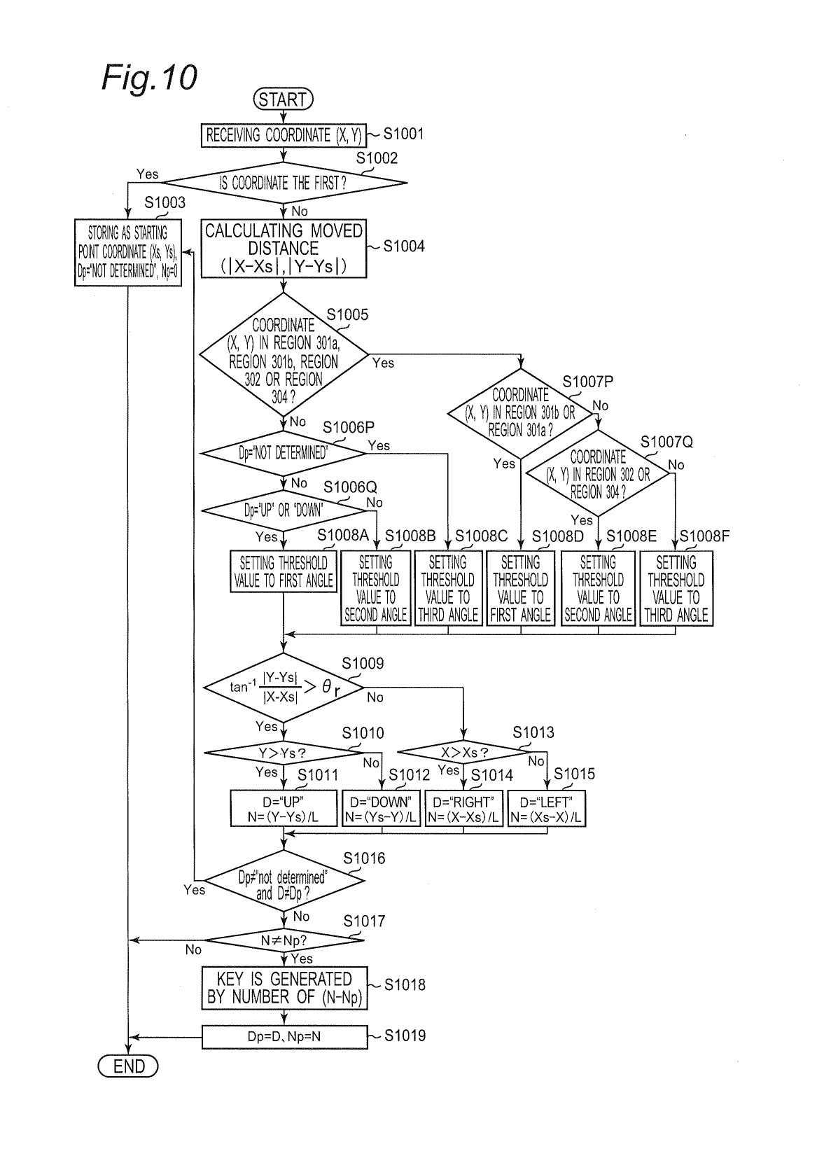

The operation for the playback device 102 to generate a move key signal has been described with reference to the flow chart of FIG. 6 in the first embodiment, and the operation for the playback device 102 to generate a move key signal has been described with reference to the flow chart of FIG. 9 in the second embodiment, respectively. In the present embodiment, an embodiment which is a combination of the processes described in the first embodiment and the processes described in the second embodiment will be described with reference to FIG. 10.

Referring to the flow chart shown in FIG. 10, following to the process step of calculating the moved distance (|X−Xs|, |Y−Ys|) from the starting point coordinates (Xs, Ys) (step S1004), when the coordinates (X, Y) are in the region other than (the top left corner region 301a, the top right corner region 301b, the bottom left corner region 302, and the bottom right corner region 304) (i.e., in the normal region 303) (step S1005, No), the set value for the threshold value for comparison θT is decided according to the same logic as that of the flow chart according to the second embodiment.

On the other hand, when the coordinates (X, Y) are in any of the top left corner region 301a, the top right corner region 301b, the bottom left corner region 302, and the bottom right corner region 304 (step S1005, Yes), the set value for the threshold value for comparison θT is decided according to the same logic as that of the flow chart according to the first embodiment.

The other processes of the flow chart shown in FIG. 10 are the same as those shown in FIGS. 6 and 9.

In the case where the input controller 207 of the playback device 102 generates the move key signal according to the flow chart shown in FIG. 10, the input controller 207 basically keeps stably recognizing the direction of movement of the finger after the finger first touched the touch pad even if the direction of movement of the finger staggers to some extent, and further, the input controller 207 properly recognizes the direction of movement even in areas near to the four corners of the touch pad 201 in which the direction of movement intended by the user is usually hard to be conveyed.

Here, the present embodiment may be configured such that when the coordinates (X, Y) are in any of the top left corner region 301a, the top right corner region 301b, the bottom left corner region 302, and the bottom right corner region 304 in the flow chart shown in FIG. 10 (step S1005, Yes), the threshold value for comparison θT is set to a third angle (i.e., 45 degrees) across the board.

Further, the present embodiment may be configured such that when the coordinates (X, Y) are in any of the top left corner region 301a, the top right corner region 301b, the bottom left corner region 302, and the bottom right corner region 304 in the flow chart shown in FIG. 10 (step S1005, Yes), the direction of movement is not calculated. That is, the present embodiment may be configured to cause the top left corner region 301a, the top right corner region 301b, the bottom left corner region 302, and the bottom right corner region 304 not to function as the touch pad.

Further, in the flow chart shown in FIG. 10, the determination in step S1005, step S1007P, and step S1007Q as well as the processing in step S1008D, step S1008E, and step S1008F are set to be performed in preference to the determination in step S1006P and step S1006Q as well as the processing in step S1008A, step S1008B, and step S1008C. That is, the present embodiment is configured to put higher priority on the same logic as that of the flow chart according to the first embodiment over the same logic as that of the flow chart according to the second embodiment in deciding the set value of the threshold value for comparison θT. That priority order may be reversed. That is, the present embodiment may be configured to put priority on the control logic based on the contact history of the finger on the touch pad over the control logic based on the contact area of the finger on the touch pad.

### 3. Other Embodiments

As described above, the first and second embodiments have been discussed as examples of the technology disclosed in the present application. However, the technology in the present disclosure is not limited to them and may also be applied to these subject to modification, substitution, addition, or omission as required. The other embodiments of the present invention will be summarized below.

First, the processing of generating the move key from the coordinates data may be performed by the controller 206 of the playback device 102 or the remote controller 101.

Although it has been described that the touch pad 201 according to the first or second embodiment is attached to the remote controller 101 and that the controller 206 (input controller 207) is attached to the playback device 102, the touch pad 201 and the controller 206 (input controller 207) according to the first or second embodiment may be attached to a portable device including a tablet terminal and a smart phone or such a device as a camera.

Although the value of the moved distance from the starting point divided by the constant L is assumed as the number of move keys N to be generated for the movement from the starting point in the first and second embodiments, the moved distance and the number of move keys to be generated may not be in proportion to each other. For example, it is possible to generate a single move key by reducing the move distance for generating the first move key and increasing the move distance for generating the second and later move keys longer than the first move key.

Although the threshold angles are 45 degrees, 30 degrees, and 60 degrees in the FIG. 5, FIG. 6, FIG. 9, and FIG. 10, the other values may be used for the angles.

### INDUSTRIAL APPLICABILITY

Although the present disclosure is related to an input device through touch pad, it can be applied to a portable device including a tablet terminal and a smart phone or such a device as a camera to which the user input flick.

What is claimed is:

1. An input device comprising:
a receiving unit for receiving a contact position on an input region of a touch pad on which a user's finger touches; and
an input controller for determining a direction of movement of the finger according to a predetermined determining condition based on the contact position on the touch pad received from the receiving unit and outputting the direction of movement, wherein
the input controller manages the input region of the touch pad by dividing the input region into a plurality of regions and changes the predetermined determining condition for each of the plurality of regions.

2. The input device according to claim 1, wherein
the input controller obtains an angle of movement of the finger based on the contact position on the touch pad received from the receiving unit and determines the direction of movement of the finger based on the angle and a predetermined threshold, and
the predetermined threshold differs for each of the divided regions of the touch pad.

3. The input device according to claim 2, wherein
the input region of the touch pad is managed as divided into five regions of a top left corner region, a top right corner region, a bottom left corner region, a bottom right corner region, and the remaining normal region, and
the predetermined threshold is set so that the movement tends to be determined as an up-down direction movement instead of a right-left direction movement in the top left corner region (301a) and the top right corner region (301b) and the movement tends to be determined as a right-left direction movement instead of an up-down direction movement in the bottom left corner region (302) and the bottom right corner region (304).

4. The input device according to claim 2, wherein
the input region of the touch pad is managed as longitudinally divided into two regions with the lower divided region further laterally divided into three regions, and
the predetermined threshold is set so that the movement tends to be determined as an up-down direction movement instead of a right-left direction movement in the upper divided region (301) and the movement tends to be determined as a right-left direction movement instead of an up-down direction movement in a right end region and a left end region (302 and 304) of the lower divided region.

5. An input device comprising:
a receiving unit for receiving a contact position on an input region of a touch pad on which a user's finger touches; and
an input controller for determining a direction of movement of the finger according to a predetermined determining condition based on the contact position on the touch pad received from the receiving unit and outputting the direction of movement, wherein
the input controller changes the predetermined determining condition based on a last direction of movement of the finger on the touch pad.

6. The input device according to claim 5, wherein
the input controller obtains an angle of movement of the finger based on the contact position on the touch pad received from the receiving unit and determines the direction of movement of the finger based on the angle and a predetermined threshold, and
the predetermined threshold differs based on a last direction of movement of the finger on the touch pad.

7. A system comprising a touch pad-equipped remote controller and a device for operating according to a signal received from the remote controller, wherein
the device comprises:
a receiving unit for receiving a contact position on an input region of a touch pad on which a user's finger touches; and
an input controller for determining a direction of movement of the finger according to a predetermined determining condition based on the contact position on the touch pad received from the receiving unit and outputting the direction of movement, wherein
the input controller manages the input region of the touch pad by dividing the input region into a plurality of regions and changes the predetermined determining condition for each of the plurality of regions.

8. A system comprising a touch pad-equipped remote controller and a device for operating according to a signal received from the remote controller, wherein
the device comprises:
a receiving unit for receiving a contact position on an input region of a touch pad on which a user's finger touches; and
an input controller for determining a direction of movement of the finger according to a predetermined determining condition based on the contact position on the touch pad received from the receiving unit and outputting the direction of movement, wherein
the input controller changes the predetermined determining condition based on a last direction of movement of the finger on the touch pad.

9. An input method comprising:
a receiving step of receiving a contact position on an input region of a touch pad on which a user's finger touches; and
an input controlling step of determining a direction of movement of the finger according to a predetermined determining condition based on the received contact position on the touch pad and outputting the direction of movement, wherein
in the input controlling step, based on the input region which is managed as divided into a plurality of regions, the predetermined determining condition differs for each of the plurality of regions of the input region of the touch pad.

10. An input method comprising:
a receiving step of receiving a contact position on an input region of a touch pad on which a user's finger touches; and
an input controlling step of determining a direction of movement of the finger according to a predetermined determining condition based on the received contact position on the touch pad and outputting the direction of movement, wherein
in the input controlling step, the predetermined determining condition differs based on a last direction of movement of the finger on the touch pad.
